(19) United States
(12) Patent Application Publication
(10) Pub. No.: US 2006/0287829 A1
(43) Pub. Date: Dec. 21, 2006

(54) Object proximity warning system

(76) Inventor: Dimitri Pashko-Paschenko, Albany, OR (US)

Correspondence Address: LAURENCE C. BONAR, 917 LOGAN ST, PORT TOWNSEND, WA, 98368-2337, US

(21) Appl. No.: 11/451,884

(22) Filed: Jun. 12, 2006

Related U.S. Application Data
(60) Provisional application No. 60/691,154, filed on Jun. 15, 2005.

(51) Int. Cl. G08G 1/16

(52) U.S. Cl. 701/301; 340/436

(57) ABSTRACT

A system and method are provided to detect an impending contact or collision between a subject vehicle, which may be an aircraft, a watercraft or a load-handling vehicle, and stationary objects or other vehicles in the vicinity of the subject vehicle, comprising distance or motion-detecting sensors mounted at positions on the subject vehicle at risk of such collision or contact, and alerting means, responsive to said sensors, to notify the operator of the subject vehicle and/or the operators of such other vehicles in the vicinity of the subject vehicle of the risk of a collision. Preferred embodiments comprise alerting means which indicate to the operator of the subject vehicle which, if any, sensors detect an object closer too the subject vehicle than a predetermined distance of safe approach.

### TECHNICAL FIELD OF THE INVENTION

This invention relates to the systems for detecting an impending collision between a vehicle and an object in the vehicle's surroundings and alerting the operator to take action to avoid the collision.

### BACKGROUND

Many vehicles have “blind spot”-parts of the vehicle that are not readily visualized by the operator. Other vehicles have multiple parts which can potentially impact objects in the vehicle's surroundings, so that it is difficult for the operator to maintain constant surveillance of all such exposed parts simultaneously. Such vehicles are difficult to maneuver in crowded locations such as may be encountered in parking or storing the vehicle, or to approach a loading dock, dock or similar structure. Vehicles with such blind spots include aircraft being maneuvered on the ground, many types of trucks; agricultural equipment such as combines, hay-balers and tractor-drawn plows, harrows, cultivators, etc; industrial specialty vehicles such as lumber-handlers (vehicles with high clearance which straddle a stack of lumber and lift it for transport to another site), boat-hauling devices, fork lifts; and construction equipment such as excavators and cranes.

Furthermore, vehicles that are stationary or parked are frequently at risk from damaging contact from another vehicle moving in the vicinity of the stationary vehicle.

In what follows, “vehicle” shall mean any vehicle capable of motion with respect to its surroundings, whether under its own power or being pulled or pushed by other means. “Operator” shall mean the person controlling the movement of the vehicle, whether controlling the vehicle itself or controlling the external means of moving the vehicle. Parts of the vehicle likely to come into contact with an object in the surroundings will be denoted an “at-risk contact point”.

Also in what follows, the term “object” will mean any object in the area surrounding a vehicle in question; “obstacle” will mean an object which will cause a collision with a moving vehicle if the vehicle continues along its present path.

In addition to the obstacle-avoidance applications outlined above, there are situations where the normal operation of a vehicle may involve picking up a load or object and where the region of contact between vehicle and load or object cannot be seen by the operator. Lumber-handlers (vehicles with high clearance which straddle a stack of lumber and lift it for transport to another site) and some fork lifts, particularly high-lift fork lifts, suffer from this problem.

A particularly serious problem is encountered in operation of aircraft on the ground during such operations as taxiing, parking, docking, hangaring, and other operations requiring the positioning of an aircraft on the ground in congested areas. Such operations are often carried out by a single unaided operator who has restricted or no vision of some parts of the aircraft which are potential points of collision with surrounding objects such as other aircraft, hangar walls or doors, or stationary obstacles. Whether the operator is moving the aircraft under its own power or is moving the aircraft with a tractor, or, in the case of small aircraft, moving it by hand, he/she must continuously be aware of the spatial relationship of all the multiple potential collision points of the aircraft with surrounding obstacles. And since even a minor collision can do extensive damage which is very expensive to repair, the importance of avoiding collision is very high. Because of crowded conditions on the tarmac at many airports, there is a need for a system to assist the operator to avoid such collisions is particularly strong and immediate.

There is also the additional hazard to aircraft in the use of service vehicles, such as baggage loaders, catering vehicles, sanitary service vehicles, fueling vehicles, etc., which must approach close to a parked aircraft, and which are often of such construction that visibility of the area between vehicle and aircraft is limited or non-existent. Several instances of collisions between baggage loading vehicles and commercial aircraft have recently occurred, resulting in damage to the aircraft which did not become apparent until the aircraft was airborne, and requiring emergency landings.

A similar problem exists for many ships and boats, where close approach to such objects as docks and lock walls may be necessary, and where surveillance of blind spots which might impact such objects with damaging force is needed.

It would be desirable for vehicles with blind spots or multiple potential collision sites to be equipped with suitable sensors which will alert the operator if an impending collision is detected with at-risk parts of the vehicle. Alternatively, fixed obstacles or structures such as loading docks, garages, hangars, docks or the like could be equipped with suitable sensors and warning devices which could emit audible and/or visual signals when any part of a vehicle approached such obstacle or structure too closely. The former embodiments will be hereinafter be referred to as “active” object proximity warning systems, and the latter as “passive” object proximity warning systems. The present invention provides such systems of sensors and alerting means.

In the case of load-handling vehicles such as lumber-handlers and high-lift fork lifts, a system to provide the vehicle operator with information as to closeness of approach of the load-engaging means to the load is needed, and the present invention also provides systems of sensors and alerting means which can provide such information to the vehicle operator.

Systems to avoid collisions of motor vehicles under way at normal driving speeds with other vehicles or fixed obstacles are well known. See for example Isgai et al, U.S. Pat. No. 6,889,140; Rao et al, U.S. Pat. No. 6,864,783. Such systems generally use electromagnetic wave radar to determine if another vehicle or a stationary object poses a likelihood of collision, and alerts the driver and/or slows the vehicle. Such systems are typically designed to provide warnings of objects one or more car lengths distant, and lack the spatial resolution and distance-of-approach resolution to permit maneuvering in crowded environments, parking, garaging/hangaring, etc.

Systems for motor vehicles to provide indication of close approach to obstacles, generally in the context of assisting or directing the operator in parking the vehicle, are also well known. See, for example, U.S. Pat. No. 6,690,616 to Bahr, et al; U.S. Pat. 6,879,914 to Hoenes et al; U.S. Pat. No. 6,819,284 to Maier et al; and U.S. Pat. No. 6,100,796 to Wagner et al. The internet web page at URL: htt://www.bmwusa.com/bmwexperience/BmwTechnology/luxury illustrates a commercial embodiment of such systems. Such systems generally utilize ultrasonic transducers sensing distances of the order of a few inches to several feet.

Systems for collision avoidance for airborne aircraft are also known. See, for example, U.S. Pat. No. 6,804,607 to Wood; U.S. Pat. No. 6,795,772 to Lin, et al; and U.S. Pat. No. 6,789,016 to Bayh, et al. Such systems rely on electromagnetic radar and sophisticated communications to avoid collisions with other aircraft or the ground. Such systems would not be applicable to maneuvering aircraft on the ground in crowded airports in such a way as to avoid collisions.

Rast, U.S. Pat. Nos. 6,486,798 and 6,963,293, describes systems and apparatus for use in aircraft on the ground to detect potential collisions, based on wingtip-mounted lasers directing a beam in a forward direction, and sensors which detect laser radiation scattered by or reflected off objects in front of the aircraft and warn the operator of a potential collision. The lasers of the Rast invention are highly directional, and while they may detect potential collisions with objects in front of the wingtips, they do provide corresponding warning of impending collision involving other directions or other parts of the aircraft.

There is, therefore, a need for a more generally applicable object detecting and alerting system operable at short distances—about a foot or two to perhaps 10 to 20 feet, depending on the vehicle in question, for embodiments for avoiding collisions, or as little as a few inches in embodiments for load detection—which can be used to alert an operator of the proximity of obstacles which pose threats of collision or close approach, There is also a need for systems detecting the close approach to and contact with a load or object to be picked up. Provision of such systems are the objective of the present invention.

### OBJECTS AND SUMMARY OF THE INVENTION

It is an objective of the Object Proximity Warning System of the present invention to provide a system which can detect an object or obstacle which poses a collision threat to a vehicle, and alert the operator of the vehicle to the threat, so that corrective action may be taken.

It is another objective of the Object Proximity Warning System of the present invention to provide a system comprised in a vehicle which can detect an object or obstacle which poses a collision threat to a vehicle, and alert the operator of the vehicle to the threat, so that corrective action may be taken.

It is further objective of the Object Proximity Warning System of the present invention to provide a system comprised in a vehicle which can alert the operator and provide the operator information on potential collisions whether the vehicle is being operating under its own power or by means of external moving means.

It is further objective of the Object Proximity Warning System of the present invention to provide a system comprised in a vehicle which will generate warning signals if movement of another vehicle in the vicinity poses a risk of collision.

It is a still further objective of the Object Proximity Warning System of the present invention to provide, in an alternate embodiment, a system comprised of proximity detecting and warning-generating means comprised on obstacles which can alert the operator of a vehicle that a collision with the obstacle is imminent unless corrective action is undertaken.

It is a still further objective of the Object Proximity Warning System of the present invention to provide, in an alternate embodiment, a system which can provide information to the operator of a load-handling vehicle with respect to how close the load-contacting means are to the load.

These objectives are met by providing, in active warning systems, a plurality of distance-determining sensors on at-risk parts of a subject vehicle, and display and alerting means which can monitor the sensor measurements and provide the vehicle operator, or the operators of other vehicles whose movements pose a risk to the subject vehicle, information with respect to the closeness of approach of such parts to a surrounding object.

These objectives are also met by providing, in passive warning systems, one or more distance determining sensors and display and alerting means on objects to provide information to the operator of a nearby vehicle with respect to the closeness of approach to the object.

These objectives are also met for load-handling vehicles by providing one or more distance-determining sensors on the load-engaging means of the vehicle, and display and alerting means which can monitor the sensor measurements and provide the vehicle operator with information with respect to the closeness of approach of such load-engaging means to the load.

### BRIEF DESCRIPTION OF THE DRAWING

FIG. 1 illustrates a preferred embodiment of the present invention, as applied to a small aircraft being positioned by an external operator.

### DETAILED DESCRIPTION OF THE INVENTION

The Object Proximity Warning System of the present invention comprises one or more distance-determining sensors together with display and alerting means responsive to said sensors to provide information to the operator of a subject vehicle with respect to the closeness of approach of the subject vehicle to an object, or the closeness of approach of another vehicle to the subject vehicle. In active embodiments of the present invention, said sensors will be comprised in a subject vehicle, and will provide information to the operator of the vehicle, or to the operators of other vehicles moving in the vicinity of the subject vehicle, with respect to the closeness of approach of the vehicle to virtually any object. In passive embodiments, said sensor or sensors will be comprised in objects with which a vehicle might collide, and will provide information to vehicle operators with respect to closeness of approach to virtually any vehicle.

In other embodiments, the Object Proximity Warning System of the present invention comprises one or more motion detectors similarly linked to display and alerting means responsive thereto. Motion detectors will detect relative motion between the detector and a nearby object, and would produce alerting signals whether the motion was the motion of the subject vehicle with respect a stationary object or the motion of a second vehicle with respect to a stationary subject vehicle.

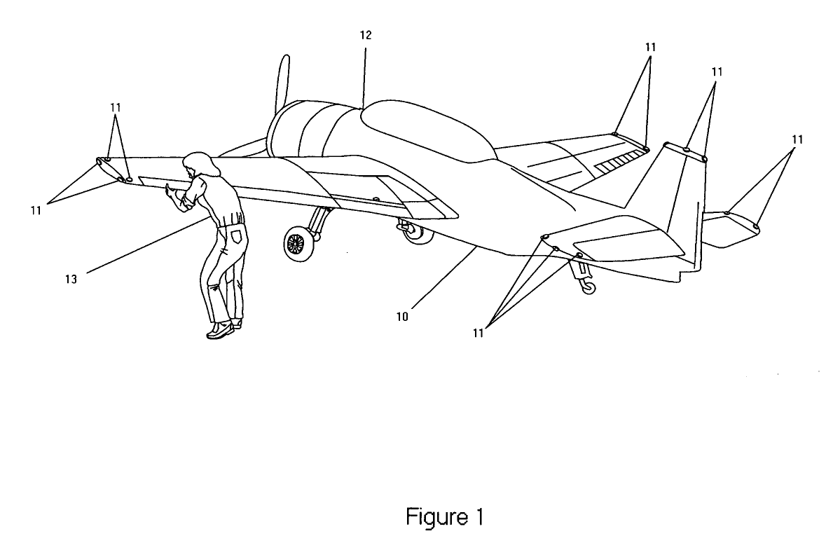

FIG. 1 illustrates a preferred active embodiment of the Object Proximity Warning System of the present invention as applied to an aircraft. Aircraft 10 comprises distance-determining sensors 11 mounted on at-risk parts of the aircraft, such as the ends of the wings, the outboard ends of the horizontal stabilizer, and the upper edge of the vertical stabilizer. Alerting means 12, which provide information to operator 13 of the closeness of approach to surrounding objects, will preferably be located in a central position such as the cockpit or flight deck of the aircraft. Alerting means may comprise an audible alert, such as a loud-speaker, which produces a sound when a sensor 11 detects an object closer than a preset limit. Preferably such sound will comprise a tone rising in pitch and/or loudness as the distance to the object decreases, ending in an intermittent “beeping” sound when a sensor 11 determines the distance to an object is less than a second, shorter limit. Thus, for example, the alerting sound may begin when a sensor 11 detects an object within a distance of 4 feet (which will be referred to hereinafter as the “outer limit distance”), rising in pitch and/or volume as the distance to said sensor decreases to 2 feet (the “inner limit distance”), at which point it will emit an intermittent sound at maximum pitch and/or loudness.

In a most preferred embodiment, the Object Proximity Warning System would be active whenever an aircraft is on the ground. Thus, any movement of the subject aircraft comprising such System which resulted in an at-risk contact point approaching an object would produce an alerting signal to the operator. Furthermore, any object such as another aircraft which approached too closely to the subject aircraft equipped with such System would similarly trigger an alert. Thus, the Object Proximity Warning System would afford protection to a parked and unattended aircraft.

The alerting system would produce alerting or warning signals readily perceived by operators of vehicles approaching subject vehicles equipped with the Object Proximity Warning System of the present invention. Such readily perceptible warning signals could comprise one or more bright flashing lights and audible signals loud enough to be heard by the operator of any approaching vehicle.

In this most preferred embodiment, the Object Proximity Warning System could be switched off, to save power, only when the aircraft is airborne, or when the aircraft's electrical system is completely shut down by means of a main circuit breaker or by disconnecting the aircraft's battery, for instance for servicing operations in a protected environment.

The alerting system could be conveniently switched on and off by the so-called “squat switch”, a switch on the landing gear of an aircraft which is activated when the aircraft's weight (or a substantial portion of it) is borne by the landing gear, which acts to prevent inadvertent retraction of the landing gear when the aircraft is on the ground. The Object Proximity Warning System could be automatically switched on when the squat switch is activated, and switched off when that switch is inactivated.

The inner and outer limit distances will preferably be determined with reference to the size of the vehicle-in the preferred embodiment an aircraft. While limits of 2 feet and 4 feet, respectively, may be suitable for a small aircraft such as illustrated in FIG. 1, limits of 5 and 20 feet, respectively, may be necessary in the case of large, less maneuverable commercial airliners, with intermediate limits being chosen for “corporate jet's” and smaller “commuter planes”. The selection of appropriate limits will be readily apparent to one skilled in the art.

Preferably, the size and type of aircraft will also determine where and how many sensors should be used to provide an appropriate level of object proximity warning. While sensors at the outboard ends of wings and stabilizer may suffice for small aircraft, larger aircraft may require sensors on the underside of the aircraft, the landing gear, or other aircraft structures which are apt to collide with an unseen object. The selection of appropriate sites for sensors will be readily apparent to one skilled in the art.

Alerting means 12 will preferably alert an operator whether the operator is in the aircraft and controlling it, or is outside the aircraft and moving the aircraft by means of a tractor or manually. Preferable alerting means will also vary with the size of the aircraft. Preferably, the internal alerting means will comprise a visual indicator indicating which sensor has detected an approach closer than the outer limit distance as well as an audible signal such as disclosed above. For small aircraft, a simple external loudspeaker on the aircraft may suffice to provide an audible signal to an external operator, with visual inspection by the external operator required to determine which part of the aircraft is approaching an object. In alternate embodiments for larger aircraft, audible alerting means for an external operator will preferably comprise headphones, either connected by cable to a suitable Proximity Warning System outlet on the exterior of the aircraft or via a “wireless” radio signal from the aircraft. Selection of the appropriate alerting means and implementation of the selected means are well within the purview of one skilled in the art.

Sensors 11 may be any distance-sensing transducers known to the art, such as electromagnetic-wave radar, ultraviolet, visible or infrared lasers or electronic mass detectors. Preferably, sensors 11 will be ultrasonic emitter-receiver transducers. Ultrasonic transducers are particularly well suited to use in the present invention: they are small in size and low in power consumption. They are available with a wide variety of ranges of distance detection and resolution. Depending on the ultrasonic frequency and other parameters selected, ultrasonic transducers can have a range of up to about 100 feet, and can measure distances down to less than 2 inches. A given transducer can have a useable range of about 25 or more times the minimum detectable distance—i.e., a transducer can be selected to be useable from a distance of one foot to 25 feet or more.

Suitable ultrasonic transducers may be purchased from Airmar Technology Corporation of Milford, N.H., or any other supplier. Transducers such as Airmar's model AT200, operating at a nominal frequency of 200 khz and with a useable detectability range of 4 inches to 10 feet, and model AT75, with a useable detectability range of less than one foot to 30 feet, would be suitable for use in the Proximity Warning System of the present invention.

In general, transducer operating frequencies should be as high as possible consistent with the desired distance-measuring range (which range decreases with increasing frequency), to avoid specular reflection from potentially hazardous objects. An object will appear to be specular to an ultrasonic transducer if the object's surface structure only has features small compared with the transducer's ultrasound wavelength; specular reflection is highly directional, and a specularly reflected ultrasonic pulse will not be detected by a transducer unless the specular object's surface is approximately perpendicular to the transducer axis. Objects with surface features large compared to the wavelength of the ultrasound beam employed will scatter the beam diffusely, and such objects will be detectable regardless of shape and location in the beam.

Ultrasonic transducers are inherently analog in nature-that is, the delay time of a reflected ultrasonic pulse is directly related to the distance from transducer to reflecting object. However, by establishing distance thresholds for transducers, a sensor system that is essentially binary can be provided. That is, a given transducer (with its associated signal-processing electronics) can be configured to respond only if an object closer than the threshold distance. In an alternate embodiment of the Proximity Warning System of the present invention, an aircraft could comprise arrays of transducer pairs deployed on at-risk parts of the aircraft, with thresholds of each pair set at the desired inner and outer limit distances. A signal would then be received from the outer limit distance transducer if an object was determined to be closer than this limit, and a signal would be received from both transducers if it was closer than the inner limit distance. Alerting means appropriate to such a three-state system (no signal, signal from one sensor, signals from both sensors) would preferably comprise an audible alert, with a continuous tone when the outer limit distance was broached, and an intermittent sound, which may be at a higher tone, if both limits were broached.

Ultrasonic transducers have directional characteristics. A given transducer will have a detectability envelope of about 10 to about 30 degrees-that is, it can detect objects within 10 to 30 degrees of its axis, depending somewhat on the distance of the object from the transducer. In preferred embodiments of the present invention as applied to aircraft, parts of the aircraft to be protected with the Proximity Warning System will comprise arrays of ultrasonic transducers with overlapping detectability envelopes, so that approach of a protected part of the aircraft to an object from any direction will be detected and the appropriate alert produced.

In an alternate embodiment, a smaller number of ultrasonic transducers will be mounted on each at-risk part of the aircraft, but the detectivity envelope of at least some of the transducers will be swept over a horizontal area by mechanical or electronic means, to provide full coverage of the region surrounding such exposed part.

Alerting means will preferably comprise means to receive signals from all sensors either in parallel or sequentially, identify the source sensor for each signal, and determine if there is a collision threat-that is, the possibility of collision with the part on which the sensor is mounted. Preferred alerting means will also comprise a visual display unit in the cockpit or flight deck of the aircraft which permits the operator of the aircraft to identify the particular sensor or sensors providing a collision threat signal. Such visual display unit will preferably comprise an image or images of the aircraft, with the sensors detecting a nearby object highlighted. In a most preferred embodiment, sensors detecting a nearby object will blink with a blinking frequency and/or intensity increasing as the distance to the nearby object decreases. Preferred alerting means will also comprise audible warning means as described hereinabove.

For larger aircraft, alerting means will preferably comprise hand-held or tractor-mounted visual displays which function as described above.

In alternate embodiments described hereinabove utilizing ultrasonic transducers in a binary mode, visual alerting means could comprise a display of an image or images of the aircraft with transducers detecting an object closer than the outer limit distance highlighted, and transducers detecting an object closer than the inner limit distance highlighted and blinking.

In further alternate embodiments, the Proximity Warning System of the present invention may also comprise means to halt the aircraft if a sensor detects approach to an object closer than the inner distance limit. Such means to halt the aircraft would preferably comprise a manual reset switch such that the operator could resume movement of the aircraft after the collision threat had been identified and corrective action determined.

Implementation of such alerting means and halting means are well within the purview of one skilled in the art.

Alerting means may, in alternative embodiments, comprise “distributed” signal processing elements, such that sensors in, for example, a wingtip may send signals to a signal processing unit located in the wingtip; this signal processing unit will perform preliminary signal processing, and transmit a signal to the centrally located portion of the alerting means only if an object is detected closer than a preset threshold distance is detected, which signal will identify the affected transducer or transducers. This alternate embodiment will reduce the amount of cabling required in the wing or other part of the aircraft. Details of such distributed processing system will be readily apparent to one skilled in the art.

The hereinabove described embodiments are active embodiments of the Object Proximity Warning System of the present invention. Passive embodiments of the invention comprise suitable sensors and alerting means deployed on objects with which a vehicle is likely to collide. Such embodiments would be particularly useful for loading docks, garage or hangar doors and walls, fueling facilities or the like, which a vehicle may approach closely but must not collide with.

A preferred passive embodiment of the present invention will comprise sensors mounted along the floor or wall of an aircraft hangar, and alerting means which will produce audible and/or visual alerting signals if any part of an aircraft approaches closer than a preset distance from the wall. Alerting means could comprise a loud sound, which could vary in pitch or become intermittent as the distance decreased, and a bright flashing light, to alert the operator of the aircraft of an impending collision.

As with preferred active embodiments, ultrasonic transducers would be preferred for such embodiments. Transducers with a range similar to the height of the hangar walls would be selected.

An alternate passive embodiment of the present invention would comprise a laser located near the wall of a hangar and continuously scanning, by means of a rotating mirror or other scanning means known to the art, in a plane parallel to the wall, and one or more detectors tuned to the wavelength of the laser distributed nearby. Any part of an aircraft intruding into the plane of the laser would interrupt, reflect and scatter the laser beam. Laser detectors mounted in the scanning plane would detect interruption of the beam, while detectors mounted outside the scanning plane could detect reflected or scattered laser radiation. The laser could operate in the UV, visible or IR spectrum, and would be selected to minimize danger to personnel from inadvertent exposure to the laser.

Other passive embodiments of the Object Proximity Warning System of the present invention would comprise alerting means which transmit a warning signal via wireless transmission means to vehicles equipped with appropriate receivers for such signals.

Embodiments of the Object Proximity Warning System of the present invention to ships, boats or other watercraft would comprise, in the case of active embodiments, sensors located along the sides of the hull, on the bowsprit or similarly projection structure, on the tops of any masts, and at other at-risk contact points. The System would warn the operator of the approach to a too low bridge, for example, or if the bowsprit was about to collide with another watercraft while maneuvering in crowded marinas or mooring areas. Such a System would also be useful when approaching a dock or lock wall. The system would be particularly useful in the case of sailboats longer than about 30 feet, and particularly in the case of single-handed operation of such watercraft. The operator of such boats is generally positioned toward the stem of the craft, and has limited or no visibility of the bow region.

Passive embodiments of the Object Proximity Warning System of the present invention to watercraft would comprise distance-measuring sensors mounted on docks slips, etc. as an aid to boaters approaching such facilities.

Embodiments of the Object Proximity Warning System of the present invention applicable to industrial load-handling vehicles would comprise distance-measuring sensors mounted on load-engaging means of such vehicles.

By load-handling vehicles is meant vehicles specially adapted to pick up and transport loads or objects relatively short distances off-road. Examples are fork-lifts, especially high-lift fork-lifts, straddle-carriers to move stacks of lumber, boat-lifting and moving vehicles, and vehicle-mounted aircraft baggage-handling conveyor belts which facilitate moving cargo or luggage into cargo holds.

Further embodiments of the Object Proximity Warning System of the present invention would comprise equipping cargo-container cranes or construction cranes with suitable distance-determining transducers to provide guidance to the crane operator as to the distance from the load.

In lumber-handlers, for example, the operator cannot see the load-engaging means. Distance-measuring sensors and alerting means could indicate to the operator how close the load-engaging means are to the load. Similar advantages would be gained for high-lift fork-lifts, where the operator has very limited vision of the load-engaging means.

A particular embodiments of the Object Proximity Warning System of the present invention applicable to industrial load-handling vehicles would comprise equipping aircraft baggage loaders with distance-measuring sensors and suitable alerting means connected to the sensors, so the operator of the baggage loader could safely approach an aircraft sufficiently closely to facilitate baggage handling without risk of even a minor contact or collision with the aircraft.

An alternate embodiment of the present invention to load-carrying vehicles would comprise dismountable arrays of distance measuring sensors, with associated alerting means, temporarily deployed on the load, to assist the operator of the vehicle in maneuvering vehicle and load. Such a dismountable proximity warning system would be particularly useful for boat-hauling cranes or lifters (vehicles which straddle a boat and lift it by means of cables or webbing deployed underneath the boat), where the length of the “load” may considerable exceed the length of the vehicle, and where the lifted boat must often be maneuvered in crowded boat-yards. Another application of such dismountable proximity warning system would be to vehicles carrying or towing loads of length, width or height exceeding highway limits.

In the case of agricultural vehicles, embodiments would comprise distance-measuring sensors mounted on the rear and other blind spots of combines, hay-balers, and similar awkward vehicles, with alerting means to assist the operator in maneuvering the vehicles. Alternate embodiments would comprise sensors mounted on harrows, cultivators and similar tractor-drawn vehicles, with alerting means locating in the tractor, also to assist the operator in maneuvering the vehicles.

Other embodiments will be apparent to one skilled in the art, which will change various details of the present invention without limiting its scope. Furthermore, the foregoing description of the preferred embodiment of the invention and the best mode for practicing the invention are provided for the purpose of illustration only and not for the purpose of limitation of the invention, which will be defined by the claims appended hereto.

1. A method of detecting potential collisions between a vehicle which is an aircraft on the surface of the earth, a watercraft or a load-handling vehicle, and objects on the surface of the earth in the vehicle's surroundings, comprising:
equipping said vehicle with a plurality of transducers capable of detecting objects near the transducers; and
equipping said vehicle with an alerting system which will generate one or more alarm signals if an object is detected closer to said aircraft than a predetermined distance of safe proximity.

2. The method of claim 1 wherein said alerting system will further identify to the operator of said vehicle which, if any, of said transducers has been approached closer than said predetermined distance of safe proximity.

3. The method of claim 1 wherein said transducers comprise ultrasonic transducers.

4. The method of claim 1 wherein said transducers comprise motion detectors.

5. The method of claim 1 wherein said transducers and said alerting means are removably attachable to said first vehicle.

6. A system for detecting potential collisions between a first vehicle which is an aircraft on the surface of the earth, a watercraft or a load-handling vehicle, and objects, including other vehicles, on the surface of the earth in the vehicle's surroundings, comprising:
a plurality of transducers attached to said first vehicle capable of detecting objects near the transducers; and
alerting means responsive to said transducers which will generate one or more alarm signals if an object is detected closer to said first vehicle than a predetermined distance of safe proximity.

7. The system of claim 6 wherein said alerting means comprise means to identify to the operator of said first vehicle which, if any, of said transducers has been approached closer than said predetermined distance of safe proximity.

8. The system of claim 6 wherein said alerting means comprise means to produce audible signals to alert operators of second vehicles approaching closer to said first vehicle than a predetermined distance of safe proximity to said first vehicle.

9. The system of claim 6 wherein said transducers comprise ultrasonic transducers.

10. The system of claim 6 wherein said transducers comprise motion detectors.

11. The system of claim 6 wherein said transducers and said alerting means are removably attachable to said first vehicle.

12. An aircraft on the surface of the earth comprising a plurality of transducers capable of detecting objects on the surface of the earth near the transducers, and alerting means responsive to said transducers which will generate one or more alarm signals if an object is detected closer to said aircraft than a predetermined distance of safe proximity.

13. The aircraft of claim 12 wherein said alerting means comprise means to identify to an operator of said aircraft which, if any, transducers detects an object closer to said aircraft than a predetermined distance of safe proximity.

14. The aircraft of claim 12 wherein said alerting means comprise audible signals to alert operators of vehicles approaching closer to said aircraft than a predetermined distance of safe proximity to said aircraft.

15. The aircraft of claim 12 wherein said transducers comprise ultrasonic transducers.

16. The aircraft of claim 12 wherein said transducers comprise motion detectors.

17. The aircraft of claim 12 wherein said transducers and said alerting means are removably attachable to said aircraft.
